(19) United States
(12) Patent Application Publication
(10) Pub. No.: US 2011/0156386 A1
(43) Pub. Date: Jun. 30, 2011

(54) SHIMMED JOINT, GASKET FOR A SHIMMED JOINT, AND METHOD FOR SEALING A SHIMMED JOINT

(75) Inventors: Donald Malinowski, Hagerstown, MD (US); Matthew Elliott, Palmyra, PA (US); Mark Winders, Hagerstown, MD (US)

(73) Assignee: Mack Trucks, Inc., Greensboro, NC (US)

(21) Appl. No.: 12/997,787

(22) PCT Filed: Jun. 26, 2008
(86) PCT No.: PCT/US08/68316

§ 371 Date: Dec. 13, 2010

(51) Int. Cl. F16L 19/025; F16J 15/02

(52) U.S. Cl. 285/335; 277/607; 277/314

(57) ABSTRACT

A shimmed joint between two components includes a first component having a first surface and a first passage extending to the first surface, and a second component having a second surface and second passage extending to the second surface. A shim is also provided. A fastener is arranged to fasten the first component relative to the second component with the shim disposed between the first surface and the second surface such that an opening in the shim aligns with and permits flow communication between the first passage and the second passage. A gasket is provided and includes a tubular portion received in at least one of the first passage and the second passage and a flange portion extending outwardly from the tubular portion and contacting the first surface and the second surface. A method of forming a shimmed joint is also disclosed.

### BACKGROUND AND SUMMARY

The present invention relates generally to shimmed joints and, more particularly, to shimmed joints including a gasket for sealing passages in the shimmed joints.

U.S. Pat. No. 7,258,641, which is incorporated by reference, discloses a power divider housing of the type in which lubricant splashed from a ring gear is collected in a trough and distributed through passages to lubricate bearing surfaces gears and shafts. Housing components in this type of power divider housing can include components such as an axle carrier and a mating power divider housing of an axle used in power divider housings such as the Powerdivider housing used in trucks provided by Mack Trucks, Inc., Allentown, Pa., U.S., and identified by Mack Part No. 36KN425. In such power divider housings, passages between chambers in the housings are provided at the interfaces of the axle carrier and the power divider housing. In such power divider housings, oil flow initiates in the axle carrier, where oil spray is captured by an oil trough and channeled in one direction through one set of aligned passages to the cavity between the pinion bearings in the power divider housing. A front tapered bearing then pumps the oil into the power divider cam cavity where the oil is then returned in the opposite direction through another set of aligned passages to an axle carrier housing oil sump.

The inventors have observed that, in such power divider housings, there tends to be oil leakage at the interface between the axle carrier and the power divider housing. This interface also serves as the location for shims used to adjust the bevel gear pattern and the inventors recognized that sealing by means of O-rings or gaskets is not practical. O-rings cannot comply with shim pack variations and stacking flat gaskets would be very expensive. Painting the standard shim with sealer after assembly has also not provide adequate to prevent oil leakage at the interface.

It is desirable to provide a shimmed joint with a passage extending through the joint, such as for a power divider assembly, with a good seal for the passage.

In accordance with an aspect of the present invention, a shimmed joint between two components comprises a first component having a first surface and a first passage extending to the first surface, a second component having a second surface and second passage extending to the second surface, a shim, a fastener arranged to fasten the first component relative to the second component with the shim disposed between the first surface and the second surface such that an opening in the shim aligns with and permits flow communication between the first passage and the second passage, and a gasket comprising a tubular portion received in at least one of the first passage and the second passage and a flange portion extending outwardly from the tubular portion and contacting the first surface and the second surface.

In accordance with another aspect of the present invention, a gasket for a shimmed joint comprises a flange having a first flange surface and a second flange surface for contacting first and second surfaces of first and second components to be connected to each other with a shim disposed between them, the flange having an outside dimension adapted to be disposed in an opening in the shim, the opening being adapted to permitting flow communication between a first passage and a second passage in the first and second components, and a tubular component extending from at least one of the first flange surface and the second flange surface and adapted to be received in at least one of the first and second passages and permitting flow communication between the first and second passages.

In accordance with yet another aspect of the present invention, a method is provided for sealing a shimmed joint. According to the method, a first component having a first surface and a first passage extending to the first surface and a second component having a second surface and second passage extending to the second surface are positioned so that the first passage aligns with the second passage. A shim is positioned between the first surface and the second surface such that an opening in the shim aligns with and permits flow communication between the first passage and the second passage. A gasket comprising a tubular portion and a flange portion extending outwardly from the tubular portion is positioned such that the tubular portion is received in at least one of the first passage and the second passage and the flange portion contacts the first surface and the second surface.

### BRIEF DESCRIPTION OF THE DRAWINGS

The features and advantages of the present invention are well understood by reading the following detailed description in conjunction with the drawings in which like numerals indicate similar elements and in which:

FIG. 1 is a cross-sectional view of a shimmed joint according to an aspect of the present invention;

FIG. 2 is a perspective view of a gasket according to an aspect of the present invention; and

FIG. 3 is an exploded view of portions of a power divider assembly including a shimmed joint.

### DETAILED DESCRIPTION

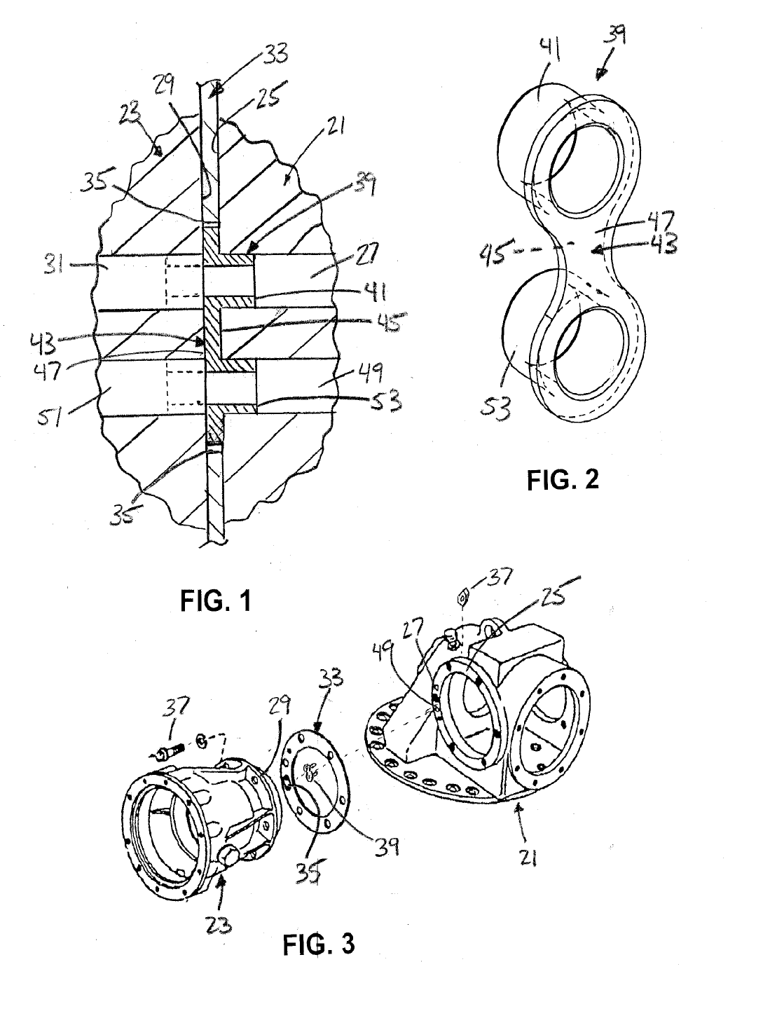

A shimmed joint between two components 21 and 23 is shown in FIG. 1. The first component 21 and the second component 23 can be any types of components between which a shim is provided, however, for purposes of discussion, the first and second components are housing components of an axle including a power divider assembly in a vehicle. A power divider assembly of this general type is disclosed in U.S. Pat. No. 7,258,641, which is incorporated by reference. The shimmed joint can be provided at the interface between components such as an axle carrier and a mating power divider housing of an axle used in trucks provided by Mack Trucks, Inc., Allentown, Pa., U.S.

In the shimmed joint shown in FIG. 1, the first component 21 has a first surface 25 and a first passage 27 extending to the first surface, and the second component 23 has a second surface 29 and second passage 31 extending to the second surface. A shim 33 is disposed between the first surface 25 and the second surface 29 and includes an opening 35 in the shim that aligns with and permits flow communication between the first passage and the second passage. The first and second surfaces 25 and 29 are ordinarily substantially flat, as are surfaces of the shim 33.

A fastener 37 (FIG. 3) is arranged to fasten the first component 21 relative to the second component 23 with the shim disposed between the first surface 25 and the second surface 29. The fastener 37 can comprise fasteners such as one or more nuts and bolts, or any suitable structure or arrangement that can fasten the first component 21 relative to the second component 23.

A gasket 39 comprising a tubular portion 41 is received in at least one of the first passage 27 and the second passage 31. As shown in phantom in FIG. 1, the tubular portion 41 may extend into both the first passage 27 and the second passage 31. The gasket 39 comprises a flange portion 43 extending outwardly from the tubular portion 41. First and second flange surfaces 45 and 47 contact the first surface 25 and the second surface 29, respectively.

While the shimmed joint can have only the first and second passages 27 and 33, FIG. 1 shows an embodiment comprising a third passage 49 extending to the first surface 25 of the first component 21 and a fourth passage 51 extending to the second surface 29 of the second component 23. HG. 1 shows the same opening 35 in the shim 33 aligning with and permitting flow communication between the third passage 49 and the fourth passage 51 that permits flow communication between the first passage 27 and the second passage 31, however, it will be appreciated that a separate opening could be provided in the shim for the third and fourth passages.

In the embodiment of FIG. 1, the gasket 39 comprises two tubular portions 41 and 53, the first one of the tubular portions 41 being received in at least one of the first passage 27 and the second passage 31 and the second one of the tubular portions 53 being received in at least one of the third passage 49 and the fourth passage 51. In this embodiment, the flange portion 43 extends outwardly from and connects the first and second tubular portions 41 and 53. It will be appreciated, however, that the first and second tubular portions could have separate flange portions that are connected to each other or not connected to each other. By connecting the flange portions to each other, it is possible to reduce the chances of the wrong gasket being installed in a particular shimmed joint, or of one of the gaskets being inadvertently omitted. While a gasket 39 with two tubular portions 41 and 53 is shown in FIG. 1, it will be appreciated that a gasket with any number of tubular portions connected to one another can be provided, with each tubular portion corresponding to pairs of aligned passages in the first and second components 21 and 23. Each tubular portion will correspond to at least one flange, and can be connected to each other by a common flange or by other suitable connecting structure.

Ordinarily, the flange portion 43 of the gasket 39 is thicker than the shim 33. In this way, when the first and second components 21 and 23 are fastened together relative to each other with the shim 33 and the flange 43 disposed between them, the flange can be compressed to facilitate enhancing a seal of the aligned passage pairs 27 and 31, and 49 and 51. In many shimmed joints, a fastener 37 fastens the first component 21 and the second component 23 together such that a predetermined pressure is applied to the shim 33 by the first surface 25 and the second surface 29. The flange 43 can have thickness and compressibility characteristics selected such that pressure applied to the flange by the first surface 25 and the second surface 29 is greater than pressure applied to the shim 33 by the first surface and the second surface. In this way, the seal provided by the gasket 39 can be superior to a seal provided by the shim 33 alone.

An outside dimension of the tubular portion 41 and 53 can be sized to correspond to and be at least as are as an inside dimension of the at least one of the first passage 25 and the second passage 31. Ordinarily, the passages 25, 31, 49, and 51 will have circular inside peripheries, and the tubular portions 41 and 53 will ordinarily also have circular exterior peripheries of at least the same diameter as the inside peripheries of the passages. The outside dimensions of the tubular portions 41 and 53 may be greater than the inside dimensions of the passage or passages 25, 31, 49, and 51 in which they are received, which may facilitate providing a better seal.

FIG. 2 shows a gasket 39 for a shimmed joint according to an aspect of the invention. The gasket 39 comprises a flange 43 having a first flange surface 45 and a second flange surface 47 for contacting the first and second surfaces 25 and 29 of the first and second components 21 and 23 to be connected to each other with the shim 33 disposed between them. The flange 43 has an outside dimension adapted to be disposed in an opening 35 in the shim, the outside dimension usually being smaller than the opening in the shim.

The gasket 39 also comprises a tubular component 41 extending from at least one of the first flange surface 45 and the second flange surface 47. The tubular component 41 is adapted to be received in at least one of the first and second passages 27 and 31 and permits flow communication between the first and second passages. The gasket can comprise a plurality of tubular components 41, 53, etc. extending from at least one of the first flange surface 45 and the second flange surface 47 of the flange 43.

In a method for sealing a shimmed joint according to an aspect of the present invention, as seen in FIG. 3 (showing housing portions of a power divider including a shimmed joint), a first component 21 having a first surface 25 and a first passage 27 extending to the first surface and a second component 23 having a second surface 29 and second passage 31 (FIG. 1) extending to the second surface are positioned relative to each other so that the first passage aligns with the second passage. A shim 33 is positioned between the first surface 25 and the second surface 29 such that an opening 35 in the shim aligns with and permits flow communication between the first passage and the second passage. A gasket 39 comprising a tubular portion 41 (FIGS. 1 and 2) and a flange portion 43 extending outwardly from the tubular portion is positioned such that the tubular portion is received in at least one of the first passage 27 and the second passage 31 and the flange portion contacts the first surface 25 and the second surface 29.

A fastener 37 can fasten the first component 21 and the second component 23 together such that a predetermined pressure is applied to the shim 33 by the first surface 25 and the second surface 29. The flange 43 can have thickness and compressibility characteristics selected such that pressure applied to the flange by the first surface 25 and the second surface 29 is greater than pressure applied to the shim 33 by the first surface and the second surface.

In the present application, the use of terms greater than and less than, or corresponding symbols, is illustrative and can be understood to comprise both greater and less than, as well as greater than or equal to and less than or equal to. The use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A shimmed joint between two components, comprising:
a first component having a first surface and a first passage extending to the first surface;
a second component having a second surface and second passage extending to the second surface;
a shim;
a fastener arranged to fasten the first component relative to the second component with the shim disposed between the first surface and the second surface such that an opening in the shim aligns with and permits flow communication between the first passage and the second passage; and
a gasket comprising a tubular portion received in at least one of the first passage and the second passage and a flange portion extending outwardly from the tubular portion and contacting the first surface and the second surface.

2. The shimmed joint as set forth in claim 1, comprising a third passage extending to the first surface of the first component and a fourth passage extending to the second surface of the second component, an opening in the shim aligning with and permitting flow communication between the third passage and the fourth passage.

3. The shimmed joint as set forth in claim 2, wherein the same opening in the shim aligns with and permits flow communication between the first passage and the second passage and between the third passage and the fourth passage.

4. The shimmed joint as set forth in claim 3, wherein the gasket comprises two tubular portions, a first one of the tubular portions being received in at least one of the first passage and the second passage and a second one of the tubular portions being received in at least one of the third passage and the fourth passage.

5. The shimmed joint as set forth in claim 4, wherein the flange portion extends outwardly from and connects the first and second tubular portions.

6. The shimmed joint as set forth in claim 1, comprising a first plurality of passages extending to the first surface of the first component and a second plurality of passages extending to the second surface of the second component, an opening in the shim aligning with and permitting flow communication between paired ones of the first plurality of passages and the second plurality of passages.

7. The shimmed joint as set forth in claim 6, wherein the gasket comprises a plurality of tubular portions, each tubular portion of the plurality of tubular portions being received in at least one passage of the paired ones of the first plurality of passages and the second plurality of passages.

8. The shimmed joint as set forth in claim 7, wherein the flange portion extends outwardly and connects the plurality of tubular portions.

9. The shimmed joint as set forth in claim 1, wherein the flange portion is thicker than the shim.

10. The shimmed joint as set forth in claim 1, wherein the first and second surfaces are substantially flat.

11. The shimmed joint as set forth in claim 1, wherein the fastener fastens the first component and the second component together such that a predetermined pressure is applied to the shim by the first surface and the second surface, the flange having thickness and compressibility characteristics selected such that pressure applied to the flange by the first surface and the second surface is greater than pressure applied to the shim by the first surface and the second surface.

12. The shimmed joint as set forth in claim 11, wherein the first component and the second component are housing components of power divider assembly in a vehicle.

13. The shimmed joint as set forth in claim 1, wherein an outside dimension of the tubular portion corresponds to and is at least as large as an inside dimension of the at least one of the first passage and the second passage.

14. The shimmed joint as set forth in claim 13, wherein the outside dimension of the tubular portion is greater than an inside dimension of the at least one of the first passage and the second passage.

15. A gasket for a shimmed joint, comprising:
a flange having a first flange surface and a second flange surface for contacting first and second surfaces of first and second components to be connected to each other with a shim disposed between them, the flange having an outside dimension adapted to be disposed in an opening in the shim, the opening being adapted to permitting flow communication between a first passage and a second passage in the first and second components; and
a tubular component extending from at least one of the first flange surface and the second flange surface and adapted to be received in at least one of the first and second passages and permitting flow communication between the first and second passages.

16. The gasket for a shimmed joint as set forth in claim 15, comprising a plurality of tubular components extending from at least one of the first flange surface and the second flange surface of the flange.

17. The gasket for a shimmed joint as set forth in claim 15, wherein, in the shimmed joint, the first component and the second component are secured together such that a predetermined pressure is applied to the shim by the first surface and the second surface, the flange having thickness and compressibility characteristics selected such that pressure applied to the flange by the first surface and the second surface is greater than pressure applied to the shim by the first surface and the second surface.

18. The gasket for a shimmed joint as set forth in claim 15, wherein an outside dimension of the tubular portion corresponds to and is at least as large as an inside dimension of the at least one of the first passage and the second passage.

19. The gasket for a shimmed joint as set forth in claim 18, wherein the outside dimension of the tubular portion is greater than an inside dimension of the at least one of the first passage and the second passage.

20. A method for sealing a shimmed joint, comprising:
positioning a first component haying a first surface and a first passage extending to the first surface and a second component having a second surface and second passage extending to the second surface so that the first passage aligns with the second passage;
positioning a shim between first surface and the second surface such that an opening in the shim aligns with and permits flow communication between the first passage and the second passage; and
positioning a gasket comprising a tubular portion and a flange portion extending outwardly from the tubular portion such that the tubular portion is received in at least one of the first passage and the second passage and the flange portion contacts the first surface and the second surface.
